(19) United States
(12) Patent Application Publication
(10) Pub. No.: US 2026/0346819 A1
(43) Pub. Date: Nov. 5, 2026

(54) BRAKE APPARATUS AND METHOD FOR CONTROLLING THE SAME

(71) Applicant: HL MANDO CORPORATION, Gyeonggi-do (KR)

(72) Inventors: Jaehoon JANG, Gyeonggi-do (KR); Geun LEE, Gyeonggi-do (KR); Hyongjin PARK, Gyeonggi-do (KR)

(21) Appl. No.: 19/396,336

(22) Filed: Nov. 21, 2025

(30) Foreign Application Priority Data
Apr. 30, 2025 (KR) 10-2025-0057630

(51) Int. Cl. B60T 8/1755; B60L 7/18; B60T 13/74

(52) U.S. Cl. CPC B60T 8/17551; B60L 7/18; B60T 13/746; B60L 2250/26; B60T 2220/04; B60T 2270/60

(57) ABSTRACT

A brake apparatus is provided. The brake apparatus may comprise a plurality of brakes provided on left wheels and right wheels of each of a first axle and a second axle of a vehicle; and a controller configured to acquire a driver-demanded braking torque based on an output signal of a pedal sensor provided in the vehicle, request regenerative braking from a driving device of the vehicle to acquire a regenerative braking torque generated during the regenerative braking, set a regenerative compensation torque based on a difference between the driver-demanded braking torque and the regenerative braking torque, distribute the regenerative compensation torque to each axle according to an axle braking ratio, and control a friction braking torque of each of the plurality of brakes based on the distributed regenerative compensation torque.

### CROSS REFERENCE TO PARENT APPLICATIONS

This application claims the benefit of Korean Patent Application Serial No. 10-2025-0057630 filed on Apr. 30, 2025, in the Korean Intellectual Property Office, the disclosure of which is incorporated herein by reference.

### BACKGROUND

Various embodiments of the present disclosure relate to a brake apparatus and a method for controlling the same, and more particularly, to prevent early occurrence of rear wheel slip during regenerative braking cooperative control and maintain regenerative braking at high deceleration.

Generally, vehicles driven by drive motors, such as hybrid vehicles or electric vehicles, perform regenerative braking using the drive motor during braking to improve fuel efficiency.

A regenerative braking system can improve fuel efficiency by converting the kinetic energy of the vehicle into electrical energy and storing it in a battery while the vehicle is braking, and using the electrical energy stored in the battery as kinetic energy for the vehicle when the vehicle is traveling.

The regenerative braking system can perform regenerative braking cooperative control that controls the sum of the regenerative braking amount generated by the drive motor and the hydraulic braking amount generated by the hydraulic braking device to satisfy the driver-demanded braking amount required by the driver during regenerative braking.

In the case of vehicles with large rear motor capacity, the amount of regenerative braking that can be performed by the rear wheels is very large. However, in the case of rear wheel vehicles, when hydraulic braking is added while regenerative braking is applied to the rear wheels, relatively more braking force is applied to the rear wheels than to the front wheels, so braking is performed mainly on the rear wheels, which easily impairs braking stability.

In addition, when slip occurs in the rear wheels due to deterioration of braking stability of the rear wheels, regenerative braking is also canceled, so the problem of having to increase the hydraulic braking amount to decelerate the vehicle continues to occur.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake apparatus may comprise: a plurality of brakes provided on left wheels and right wheels of each of a first axle and a second axle of a vehicle; and a controller configured to acquire a driver-demanded braking torque based on an output signal of a pedal sensor provided in the vehicle, request regenerative braking from a driving device of the vehicle to acquire a regenerative braking torque generated during the regenerative braking, set a regenerative compensation torque based on a difference between the driver-demanded braking torque and the regenerative braking torque, distribute the regenerative compensation torque to each axle according to an axle braking ratio, and control a friction braking torque of each of the plurality of brakes based on the distributed regenerative compensation torque.

The regenerative braking torque may include an axle-specific regenerative braking torque of either the first axle or the second axle, and the controller is configured to set the axle braking ratio based on a difference between the driver-demanded braking torque and the axle-specific regenerative braking torque, and distribute the regenerative compensation torque to each axle based on the axle braking ratio.

The controller is configured to determine a total braking torque of each axle as a sum of the axle-specific regenerative braking torque and the friction braking torque.

The controller is configured to set a reference value based on the axle braking ratio and the total braking torque of each axle, and apply the regenerative compensation torque to at least one of the first axle and the second axle based on a comparison between the reference value and the total braking torque of each axle.

The controller is configured to set the reference value as a product of the axle braking ratio and the total braking torque of the second axle based on the regenerative braking torque generated from the second axle, and apply the regenerative compensation torque to the first and second axles based on the axle braking ratio when the total braking torque of the first axle is within a reference ratio range with respect to the reference value.

The controller is configured to apply the regenerative compensation torque to the first axle when the total braking torque of the first axle is less than the reference ratio range, and apply the regenerative compensation torque to the second axle when the total braking torque of the first axle exceeds the reference ratio range.

The reference ratio range is set to be equal to or greater than 0.95 times the reference value and equal to or less than 1.05 times the reference value.

The controller is configured to set the friction braking torque associated with at least one of the first axle and the second axle equal to the axle-specific regenerative compensation torque.

The vehicle is a four-wheel drive vehicle, the regenerative braking torque includes axle-specific regenerative braking torques of each of the first and second axles, and the controller is configured to set the axle braking ratio based on a difference between the driver-demanded braking torque and the axle-specific regenerative braking torques, and distribute the axle-specific regenerative compensation torque based on the axle braking ratio.

The controller is configured to set the friction braking torque associated with each of the first axle and the second axle equal to the axle-specific regenerative compensation torque.

According to some embodiments of the present disclosure, a method for controlling a brake apparatus may comprise: acquiring a driver-demanded braking torque based on an output signal of a pedal sensor of the vehicle; requesting regenerative braking from a drive unit of the vehicle to acquire a regenerative braking torque generated during the regenerative braking; setting a regenerative compensation torque based on a difference between the driver-demanded braking torque and the regenerative braking torque; distributing the regenerative compensation torque to each axle according to an axle braking ratio; and controlling a friction braking torque of each of a plurality of brakes based on the distributed regenerative compensation torque.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a diagram illustrating a configuration of a vehicle according to one or more exemplary embodiments of the present disclosure.

FIG. 2 shows a diagram illustrating a configuration of a brake apparatus and a related vehicle according to one or more exemplary embodiments of the present disclosure.

FIG. 3 shows a diagram illustrating an example of an electromechanical brake according to one or more exemplary embodiments of the present disclosure.

FIG. 4 shows a diagram illustrating an example of the connection relationship between components included in a brake apparatus according to one or more exemplary embodiments of the present disclosure.

FIG. 5 shows a diagram illustrating torques related to cooperative regenerative braking control of a brake apparatus according to one or more exemplary embodiments of the present disclosure.

FIG. 6 shows a diagram illustrating the distribution of regenerative compensation torque related to cooperative regenerative braking control of a brake apparatus according to one or more exemplary embodiments of the present disclosure.

FIG. 7 shows a diagram illustrating torques related to cooperative regenerative braking control of a brake apparatus according to one or more exemplary embodiments of the present disclosure.

FIG. 8 shows a diagram illustrating a method for controlling a brake apparatus according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

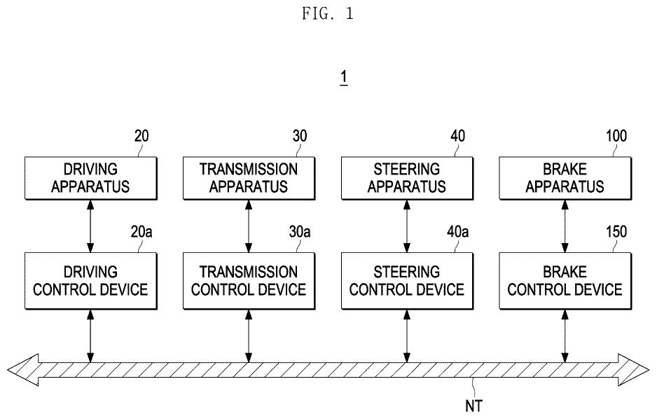

Referring to FIG. 1, a vehicle 1 may include a driving apparatus 20, a transmission apparatus 30, a steering apparatus 40, and a brake apparatus 100. The driving apparatus 20, the transmission apparatus 30, and the steering apparatus 40 are not essential components, and all or some of them may be omitted. For example, the transmission apparatus 30 may be omitted.

The driving apparatus 20 provides power for driving the vehicle 1, and may drive or accelerate the vehicle 1 in response to detection of a driver's acceleration intention through an accelerator pedal. The driving apparatus 20 may include a motor as a power source for moving the vehicle and a battery for supplying electrical energy to the drive motor as the power source. For example, an electric vehicle may include a drive motor as the power source. During acceleration of the vehicle 1, the drive motor receives power from the battery and converts the electrical energy into kinetic energy. In addition, the drive motor may convert kinetic energy into electrical energy while the vehicle 1 decelerates or brakes, and may store the converted electrical energy in the battery. Such a drive motor may perform regenerative braking for deceleration or braking.

However, the device for recovering energy in the driving apparatus 20 is not limited to the drive motor. For example, the driving apparatus 20 may further include an alternator. The alternator may convert kinetic energy into electrical energy while the vehicle 1 decelerates or brakes. Such an alternator may perform regenerative braking for deceleration or braking. Optionally, the driving apparatus 20 may further include an internal combustion engine. For example, a hybrid vehicle may include both a drive motor and an engine as power sources. The driving apparatus 20 may include only a motor, or selectively include a motor and an internal combustion engine. In addition, the driving apparatus 20 may not only drive or accelerate the vehicle 1 but may also decelerate or brake the vehicle 1 as needed. The driving apparatus 20 may include a driving control device 20a that controls the drive motor. The driving control device 20a may control the driving apparatus 20 in response to the driver's acceleration intention through the accelerator pedal. For example, the driving control device 20a may control the rotational speed and/or torque of the driving apparatus 20 and may also control regenerative braking by the drive motor.

The transmission apparatus 30 may include a plurality of gears and may transmit the power generated by the driving apparatus 20 to the wheels. The transmission apparatus 30 may include a transmission control device 30a. The transmission control device 30a may control the transmission apparatus 30 in response to a shift command of the driver through a shift lever and/or a traveling speed of the vehicle 1. For example, the transmission control device 30a may control the gear ratio from the driving apparatus 20 to the wheels.

The steering apparatus 40 may change the driving direction of the vehicle 1 and, for example, may steer the vehicle 1 in response to the detection of the driver's steering intention via a steering wheel.

The steering apparatus 40 may include a steering control device 40a. The steering control device 40a may assist the operation of the steering apparatus 40 in response to the driver's steering intention via the steering wheel.

The brake apparatus 100 provides braking force for braking the vehicle 1, and may decelerate or stop the vehicle 1 in response to the driver's braking intention through the brake pedal or in response to a request of a driving assistance device.

The brake apparatus 100 may include a brake control device 150. The brake control device 150 may control the brake apparatus 100 in response to the driver's braking intention through the brake pedal and/or a behavior of the vehicle 1. The brake control device 150 may be substantially identical to a controller 150, which will be described later.

The driving apparatus 20, the transmission apparatus 30, the steering apparatus 40, and the brake apparatus 100 may communicate through an in-vehicle communication network NT, such as Ethernet, MOST (Media Oriented Systems Transport), FlexRay, CAN (Controller Area Network), or LIN (Local Interconnect Network).

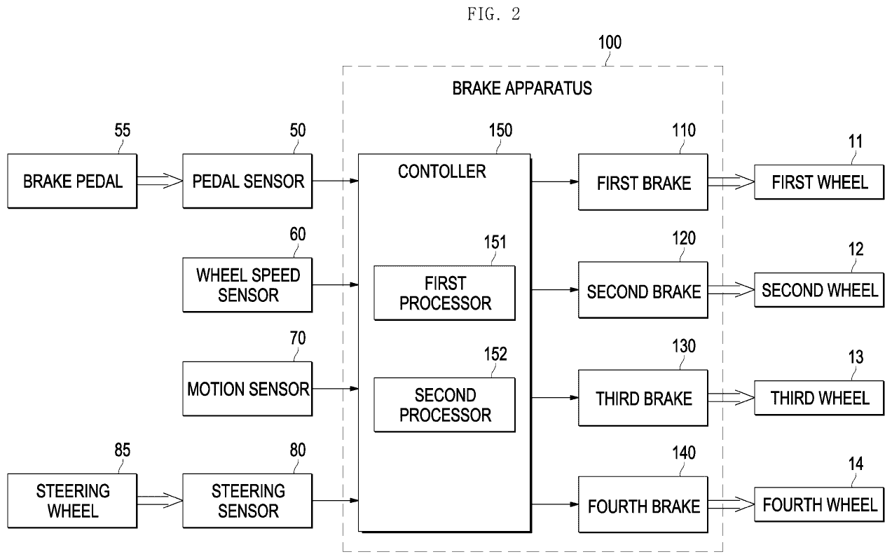

Referring to FIG. 2, the vehicle 1 may include a plurality of wheels 11, 12, 13, 14 that rotate. Each of the plurality of wheels 11, 12, 13, 14 may include, for example, a first wheel 11 provided at a front left FL of the vehicle 1, a second wheel 12 provided at a front right FR of the vehicle 1, a third wheel 13 provided at a rear left RL of the vehicle 1, and/or a fourth wheel 14 provided at a rear right RR of the vehicle 1. However, the number of wheels 11, 12, 13, 14 is not limited to four.

As shown in FIG. 2, the vehicle 1 may include a brake pedal 55 for acquiring input related to braking by the driver, a pedal sensor 50 for detecting movement of the brake pedal 55, a wheel speed sensor 60 for detecting rotational speed of each of the wheels 11, 12, 13, 14, a steering wheel 85 for acquiring input related to steering by the driver, a motion sensor 70 for detecting movement of the vehicle 1, a steering sensor 80 for detecting rotation of the steering wheel 85, and a brake apparatus 100 for providing braking force to the plurality of wheels 11, 12, 13, 14 to stop the vehicle 1. Here, the pedal sensor 50, the wheel speed sensor 60, the motion sensor 70, and the steering sensor 80 are not essential components, and all or some of them may be omitted.

The brake pedal 55 may be provided, for example, at a lower portion of the cabin so that the driver can control it with a foot. The driver may depress the brake pedal 55 as a braking intention to brake the vehicle 1. The brake pedal 55 may move away from a reference position according to the braking intention of the driver.

The pedal sensor 50 may be installed near the brake pedal 55 and may measure movement of the brake pedal 55 according to the braking intention of the driver. For example, the pedal sensor 50 may detect a movement distance and/or a movement speed from the reference position of the brake pedal 55.

The pedal sensor 50 may be electrically connected to the brake apparatus 100 and may provide an electrical signal to the brake apparatus 100. For example, the pedal sensor 50 may be directly connected to the brake apparatus 100 through hard wiring or may be connected to the brake apparatus 100 through a communication network. The pedal sensor 50 may provide an electrical signal corresponding to the movement distance and/or movement speed of the brake pedal 55 to the brake apparatus 100. In addition, the pedal sensor 50 may be provided integrally with the brake apparatus 100.

The pedal sensor 50 may include a plurality of pedal sensors to prepare for damage or failure of the electrical system. For example, the pedal sensor 50 may include a first sensor and a second sensor. The first sensor and the second sensor may each provide an electrical signal corresponding to the movement distance and/or movement speed of the brake pedal 55 to the brake apparatus 100.

The wheel speed sensor 60 may be electrically connected to the brake apparatus 100 and may provide an electrical signal to the brake apparatus 100. For example, each of the plurality of wheel speed sensors may be directly connected to the brake apparatus 100 through hard wiring or may be connected to the brake apparatus 100 through a communication network. Each of the plurality of wheel speed sensors may provide an electrical signal corresponding to the rotational speed of the plurality of wheels 11, 12, 13, 14 to the brake apparatus 100.

The motion sensor 70 may be installed near a central portion of the vehicle 1 and may include an acceleration sensor and a gyro sensor for detecting linear movement and rotational movement of the vehicle 1. The acceleration sensor may detect linear movement of the vehicle 1 and the motion sensor 70. For example, the acceleration sensor may measure acceleration, speed, displacement, and direction of movement of the vehicle 1 while the vehicle 1 is moving linearly. The gyro sensor may detect rotational movement of the vehicle 1 and the motion sensor 70. For example, the gyro sensor may measure angular acceleration, angular speed, and/or rotational displacement of the vehicle 1 while the vehicle 1 is rotating.

The motion sensor 70 may detect a yaw rate indicating rotation of the vehicle 1 about an axis perpendicular to the ground on which the vehicle 1 is traveling.

The motion sensor 70 may be electrically connected to the brake apparatus 100 and may provide an electrical signal indicating linear movement and rotational movement of the vehicle 1 to the brake apparatus 100. The motion sensor 70 may be directly connected to the brake apparatus 100 through hard wiring or may be connected to the brake apparatus 100 through a communication network. The motion sensor 70 may provide an electrical signal corresponding to the yaw rate of the vehicle 1 to the brake apparatus 100.

The steering wheel 85 may be provided, for example, in front of the driver's seat so that the driver can control it with hands. The driver may rotate the steering wheel 85 as a steering intention to steer the vehicle 1. The steering wheel 85 may rotate clockwise or counterclockwise according to the steering intention of the driver.

The steering sensor 80 may be installed near a column connected to the steering wheel 85 and may measure rotation of the steering wheel 85 according to the steering intention of the driver. For example, the steering sensor 80 may detect an angle rotated from a reference rotational position of the steering wheel 85.

The steering sensor 80 may be electrically connected to the brake apparatus 100 and may provide an electrical signal to the brake apparatus 100. For example, the steering sensor 80 may be directly connected to the brake apparatus 100 through hard wiring or may be connected to the brake apparatus 100 through a communication network. The steering sensor 80 may provide an electrical signal corresponding to a rotational angle and/or torque of the steering wheel 85 to the brake apparatus 100.

The brake apparatus 100 may include a plurality of Electro-Mechanical Brakes (EMB) 110, 120, 130, and 140 (hereinafter referred to as brakes) installed on each wheel 11, 12, 13, and 14, and a controller 150 that controls each of the plurality of brakes 110, 120, 130, and 140. The controller 150 may be implemented as an Electronic Control Unit (ECU), and may be used interchangeably with a brake control device in the present disclosure.

Each of the plurality of brakes 110, 120, 130, and 140 may brake the wheels 11, 12, 13, and 14 and brake the vehicle 1.

For example, the plurality of brakes 110, 120, 130, and 140 may include a first brake 110 for braking the first wheel 11, a second brake 120 for braking the second wheel 12, a third brake 130 for braking the third wheel 13, and/or a fourth brake 140 for braking the fourth wheel 14. The number of the plurality of brakes 110, 120, 130, and 140 is not limited to four.

Each of the plurality of brakes 110, 120, 130, and 140 may operate based solely on a braking signal output from the controller 150 without being mechanically or fluidly connected to the brake pedal 55.

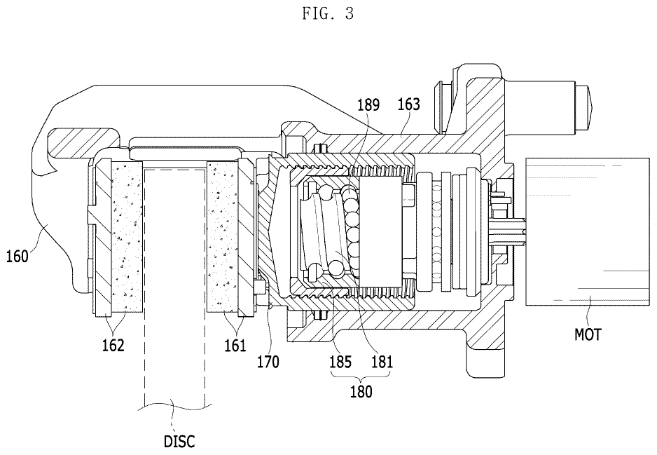

For example, as shown in FIG. 3, each of the plurality of brakes 110, 120, 130, and 140 may include a caliper brake.

The caliper brake may include a pair of pad plates 161, 162 installed to press a brake disc DISC that rotates with the plurality of wheels 11, 12, 13, 14, a caliper housing 160 that operates the pair of pad plates 161, 162, a piston 170 installed to be retractable inside the caliper housing 160, a power conversion unit 180 that receives rotational driving force to move the piston 170, converts it into linear driving force, and transmits the linear driving force to the piston 170, and a brake motor MOT that generates rotational driving force to move the piston 170.

The pad plates 161, 162, the caliper housing 160, the piston 170, the power conversion unit 180, and the brake motor MOT are not essential components, and all or at least some of them may be omitted.

The piston 170 may be provided in a cup shape with an open rear side (right side in FIG. 3) and is slidably inserted into the cylinder part 163.

Furthermore, the piston 170 may receive power through the power conversion unit 180 to press the inner pad plate 161 toward the brake disc DISC.

The power conversion unit 180 may include a spindle 181 that rotates by receiving driving force from the brake motor MOT, a nut 185 that is arranged inside the piston 170 and is screw-connected to the spindle 181 to advance with the piston 170 by the first direction rotation of the spindle 181 or to retract with the piston 170 by the second direction rotation of the spindle 181, and a plurality of balls 189 interposed between the spindle 181 and the nut 185.

Such a power conversion unit 180 may be provided as a ball-screw type conversion device that converts the rotational motion of the spindle 181 into linear motion.

The rotational motion of the brake motor MOT may be converted into the linear motion of the piston 170 by the power conversion unit 180.

Due to the linear motion of the piston 170, the pair of pad plates 161, 162 are pressed toward the brake disc DISC, and the plurality of wheels 11, 12, 13, and 14 may be braked by the friction between the pair of pad plates 161, 162 and the brake disc DISC.

FIG. 3 illustrates a caliper brake as an example of an electromechanical brake, but the brake is not limited to a caliper brake. For example, the electromechanical brake may be a drum brake.

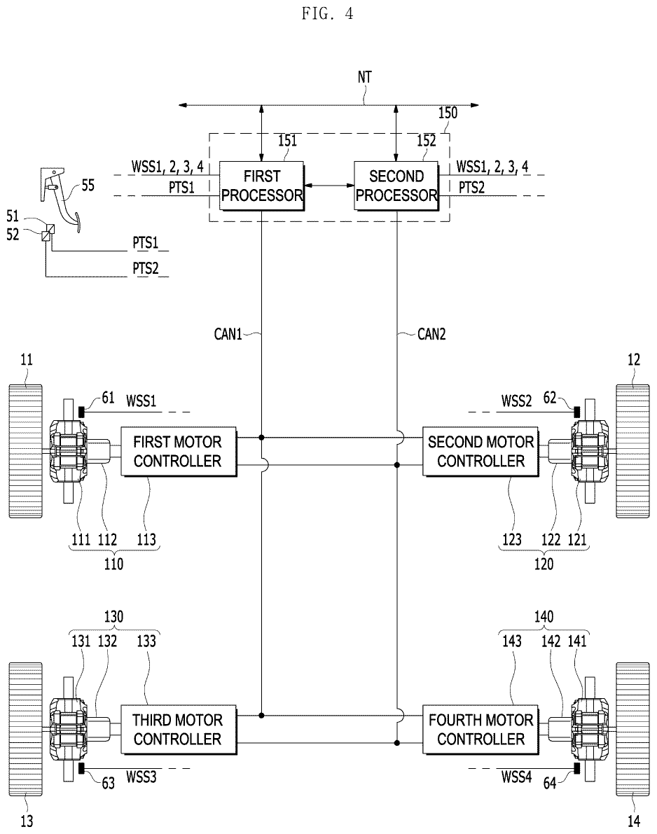

Referring to FIG. 4, the plurality of brakes 110, 120, 130, 140 may each include a brake member 111, 121, 131, 141, a brake motor 112, 122, 132, 142, and a motor controller 113, 123, 133, 143. The first brake 110 includes a first brake member 111, a first brake motor 112, and a first motor controller 113, and the first brake member 111, the first brake motor 112, and the first motor controller 113 may be integrally provided. The second brake 120 includes a second brake member 121, a second brake motor 122, and a second motor controller 123, and the second brake member 121, the second brake motor 122, and the second motor controller 123 may be integrally provided. The third brake 130 includes a third brake member 131, a third brake motor 132, and a third motor controller 133, and the third brake member 131, the third brake motor 132, and the third motor controller 133 may be integrally provided. The fourth brake 140 includes a fourth brake member 141, a fourth brake motor 142, and a fourth motor controller 143, and the fourth brake member 141, the fourth brake motor 142, and the fourth motor controller 143 may be integrally provided.

Each brake member 111, 121, 131, 141 may include a pad plate that contacts a brake disc DISC rotating with each wheel 11, 12, 13, 14 to brake the corresponding wheel. The plurality of brake members 111, 121, 131, 141 may include the first to fourth brake members 111, 121, 131, 141.

Each brake motor 112, 122, 132, 142 is an actuator and may provide torque to move a pair of pad plates so that they contact the brake disc DISC. The rotation of each brake motor 112, 122, 132, 142 is converted to linear motion through a spindle, and the linear movement of a piston causes the pad plates to contact the brake disc DISC.

Each motor controller 113, 123, 133, 143 may control a drive current for rotating each brake motor 112, 122, 132, 142 based on a braking signal from the controller 150. For example, each motor controller 113, 123, 133, 143 may include an H-bridge inverter or a three-phase inverter depending on the type of brake motor 112, 122, 132, 142. Further, each motor controller 113, 123, 133, 143 may include a drive processor, such as an ECU, configured to receive the braking signal from a processor 151, 152 of the controller 150 and control the H-bridge inverter or three-phase inverter to regulate the drive current of the brake motor 112, 122, 132, 142 based on the braking signal.

The controller 150 may receive output signals from a pedal sensor 50, wheel speed sensors 60, motion sensors 70, and/or a steering sensor 80 and control the operation of the plurality of brakes 110, 120, 130, 140. The controller 150 may process the output signals from the pedal sensor 50, wheel speed sensors 60, motion sensors 70, and/or steering sensor 80 and include a processor 151, 152 that outputs electrical signals corresponding to service brakes, EBD, ABS, TSC, ESC, EPB, and the like to the plurality of brakes 110, 120, 130, 140.

The controller 150 may include multiple processors 151, 152 to account for electrical system failures or errors. For example, the controller 150 may include a first processor 151 and a redundant second processor 152, where the second processor 152 is optional and may be omitted.

The first processor 151 may be provided separately from or integrally with any of the plurality of brakes 110, 120, 130, 140. The first processor 151 may control all of the plurality of brakes 110, 120, 130, 140 or only a portion thereof. For example, the first processor 151 integrally provided with the first brake 110 may control all of the plurality of brakes 110, 120, 130, 140 during normal operation.

The first processor 151 may process output signals from the pedal sensor 50, wheel speed sensors 60, motion sensors 70, and/or steering sensor 80 and identify braking torque, braking force, deceleration, or clamping force corresponding to service brakes, EBD, ABS, TSC, ESC, EPB, and the like based on the processed signals. The first processor 151 may output braking signals corresponding to the identified braking torque to all or some of the plurality of brakes 110, 120, 130, 140. The plurality of brakes 110, 120, 130, 140 receiving the braking signals may brake the corresponding wheels 11, 12, 13, 14 according to the applied braking force.

The first processor 151 may receive a first pedal signal PTS1 from a first pedal sensor 51 and first to fourth wheel speed signals WSS1-WSS4 from first to fourth wheel speed sensors 61, 62, 63, 64. Additionally, the first processor 151 may be connected to a vehicle communication network NT. For example, the first processor 151 may receive lateral acceleration and yaw rate signals from a motion sensor 70 and a steering angle signal from a steering sensor 80 via the vehicle communication network NT.

The first processor 151 is connected to the first to fourth motor controllers 113, 123, 133, 143 through a first communication network CAN1 and may communicate therewith. The first processor 151 may also connect to the first to fourth motor controllers 113, 123, 133, 143 via the first communication network CAN1. The first communication network CAN1 may be a dedicated network independent of the vehicle communication network NT, thereby allowing braking signals from the first processor 151 to be transmitted more quickly to the first to fourth brakes 110, 120, 130, 140, which enables faster braking of the plurality of wheels 11, 12, 13, 14. The first communication network CAN1 may utilize various communication protocols such as Ethernet, MOST Media Oriented Systems Transport, FlexRay, CAN Controller Area Network, or LIN Local Interconnect Network.

The first processor 151 may provide wheel-specific braking signals representing braking torque, braking force, deceleration, or clamping force to the first to fourth brakes 110, 120, 130, 140. For example, the first processor 151 may identify a driver-demanded braking torque based on the first pedal signal PTS1 and distribute wheel-specific braking torque to the first to fourth brakes 110, 120, 130, 140 accordingly.

The first processor 151 may identify slip and/or spin of the first to fourth wheels 11, 12, 13, 14 based on the first to fourth wheel speed signals WSS1-WSS4 and control the first to fourth brakes 110, 120, 130, 140 according to the identified slip and/or spin. The first processor 151 may transmit a parking signal to the third and fourth brakes 130, 140 to engage or release the parking brake based on a driver's parking command. In this manner, the first processor 151 may provide control signals for EBD, ABS, TSC, ESC, and EPB to the first to fourth brakes 110, 120, 130, 140.

The first processor 151 may communicate with the second processor 152. For example, the first processor 151 may periodically transmit electrical signals to the second processor 152. The second processor 152 may identify the operational status (e.g., normal or fail state) of the first processor 151 based on whether periodic status signals from the first processor 151 are received. Similarly, the first processor 151 may identify the normal operation of the second processor 152 based on received periodic status signals and identify a fail state of the second processor 152 if the periodic status signals are interrupted (e.g., due to damage, error, reset, or power loss).

The second processor 152 may be provided separately from the plurality of brakes 110, 120, 130, 140 or integrally with another one of the plurality of brakes 110, 120, 130, 140. The second processor 152 may control all of the plurality of brakes 110, 120, 130, 140 or only some of the plurality of brakes 110, 120, 130, 140. For example, the second processor 152 integrally provided with the second brake 120 may control all of the plurality of brakes 110, 120, 130, 140 in the event of a failure of the first processor 151.

The second processor 152 may process output signals from the pedal sensor 50, wheel speed sensors 60, motion sensors 70, and/or steering sensor 80, and based on the processed signals, identify braking force corresponding to service brakes, EBD, ABS, TSC, ESC, EPB, and the like, and output braking signals corresponding to the identified braking force to all or some of the plurality of brakes 110, 120, 130, 140. The plurality of brakes 110, 120, 130, 140 receiving the braking signals may brake the plurality of wheels 11, 12, 13, 14 according to the applied braking force.

The second processor 152 may receive a second pedal signal PTS2 from a second pedal sensor 52 and wheel speed signals WSS1-WSS4 from the wheel speed sensors 61, 62, 63, 64. In addition, the second processor 152 may be connected to the vehicle communication network NT independently of the first processor 151. For example, the second processor 152 may receive a yaw rate signal representing the yaw rate of the vehicle 1 from the motion sensor 70 and a steering angle signal representing the steering angle of the vehicle 1 from the steering sensor 80 via the vehicle communication network NT.

The second processor 152 is connected to the plurality of motor controllers 113, 123, 133, 143 via a second communication network CAN2 and may communicate with the plurality of motor controllers 113, 123, 133, 143 through the second communication network CAN2. The second communication network CAN2 may be a dedicated network independent of the vehicle communication network NT and the first communication network CAN1. The second communication network CAN2 may utilize various communication protocols, such as Ethernet, MOST, FlexRay, CAN, or LIN. The second processor 152 may also be connected to the first to fourth motor controllers 113, 123, 133, 143 via the second communication network CAN2.

By being independent from the vehicle communication network NT and the first communication network CAN1, the second communication network CAN2 allows braking signals from the second processor 152 to be transmitted more quickly to the plurality of motor controllers 113, 123, 133, 143, thereby enabling the plurality of brakes 110, 120, 130, 140 to brake the plurality of wheels 11, 12, 13, 14 more rapidly. The second communication network CAN2 may use various communication protocols, including Ethernet, MOST, FlexRay, CAN, or LIN.

The second processor 152 may provide braking signals representing braking torque, braking force, deceleration, or clamping force to the first to fourth brakes 110, 120, 130, 140. For example, the second processor 152 may identify a driver-demanded braking torque based on the second pedal signal PTS2 and distribute the driver-demanded braking torque to the first to fourth brakes 110, 120, 130, 140.

The second processor 152 may identify slip and/or spin of the first to fourth wheels 11, 12, 13, 14 based on the first to fourth wheel speed signals WSS1-WSS4 and control the first to fourth brakes 110, 120, 130, 140 according to the identified slip and/or spin. The second processor 152 may transmit a parking signal to the third and fourth brakes 130, 140 to engage or release the parking brake based on a driver's parking command.

In this manner, the second processor 152 may provide control signals for EBD, ABS, TSC, ESC, and EPB to the first to fourth brakes 110, 120, 130, 140. The second processor 152 may communicate with the first processor 151. For example, the second processor 152 may periodically transmit electrical signals to the first processor 151. Based on whether the periodic status signals are received from the second processor 152, the first processor 151 may identify the operating status of the second processor 152, such as normal or fail state. Conversely, the second processor 152 may periodically receive electrical signals from the first processor 151 and, based on the received periodic status signals, identify the normal status of the first processor 151 or identify a fail state of the first processor 151 when the periodic signals cease.

The second processor 152 may be implemented using semiconductor devices separate from the first processor 151. Alternatively, the second processor 152 may be implemented as processing cores provided in separate regions within a single semiconductor device together with the first processor 151.

The second processor 152 may have the same or lower processing capability than the first processor 151. For example, the number of instructions that the second processor 152 can execute per unit time may be the same as or less than the number of instructions the first processor 151 can execute per unit time.

Thus, the controller 150 allows the second processor 152 to control the plurality of brakes 110, 120, 130, 140 in the event of a failure of the first processor 151, and the first processor 151 may control the plurality of brakes 110, 120, 130, 140 in the event of a failure of the second processor 152.

Meanwhile, referring to FIG. 4, the pedal sensor 50 may include a first pedal sensor 51 and a second pedal sensor 52.

The first pedal sensor 51 and the second pedal sensor 52 may each detect the movement of the brake pedal 55 and provide electrical output signals PTS1, PTS2 corresponding to the movement (e.g., displacement and/or speed) of the brake pedal 55 to the first processor 151 and the second processor 152, respectively.

For example, the first pedal sensor 51 is electrically connected to the first processor 151 and may provide a first pedal signal PTS1 to the first processor 151.

The second pedal sensor 52 is electrically connected to the second processor 152 and may provide a second pedal signal PTS2 to the second processor 152.

The wheel speed sensor 60 may include a plurality of wheel speed sensors 61, 62, 63, and 64 installed on each of the plurality of wheels 11, 12, 13, and 14.

Each of the plurality of wheel speed sensors 61, 62, 63, and 64 may independently detect the rotational speed of the plurality of wheels 11, 12, 13, and 14.

Each of the plurality of wheel speed sensors 61, 62, 63, and 64 may provide electrical output signals WSS1, WSS2, WSS3, WSS4 corresponding to the rotational speed of the plurality of wheels 11, 12, 13, and 14 to the first processor 151 and the second processor 152, respectively.

For example, the first wheel speed sensor 61 provides a first wheel speed signal WSS1 corresponding to the rotational speed of the first wheel 11 to the first processor 151 and the second processor 152, and the second wheel speed sensor 62 provides a second wheel speed signal WSS2 corresponding to the rotational speed of the second wheel 12 to the first processor 151 and the second processor 152.

The third wheel speed sensor 63 provides a third wheel speed signal WSS3 corresponding to the rotational speed of the third wheel 13 to the first processor 151 and the second processor 152, and the fourth wheel speed sensor 64 provides a fourth wheel speed signal WSS4 corresponding to the rotational speed of the fourth wheel 14 to the first processor 151 and the second processor 152.

In other words, the first processor 151 and the second processor 152 may each acquire the wheel speed signals WSS1-WSS4 from the first, second, third, and fourth wheel speed sensors 61, 62, 63, and 64.

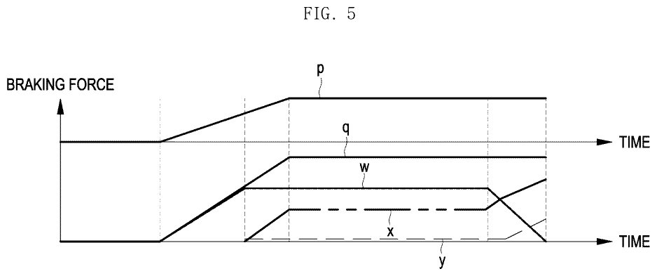

Referring to FIG. 5 to FIG. 7, the controller 150 may request regenerative braking from the vehicle's driving apparatus 20 and acquire regenerative braking torque generated during regenerative braking.

The driving apparatus 20 may generate regenerative braking torque only at the second axle (rear wheels) for a rear-wheel drive (RWD) vehicle, and may generate regenerative braking torque at both the first axle (front wheels) and the second axle (rear wheels) for a 4-wheel drive (4WD) vehicle.

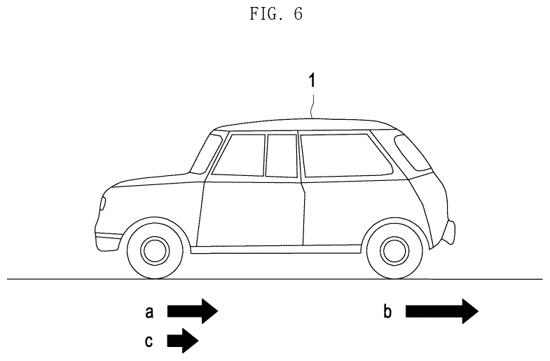

FIG. 5 and FIG. 6 are diagrams for explaining cooperative regenerative braking control in a rear-wheel drive (RWD) vehicle.

Referring to FIG. 5, the controller 150 may acquire the driver's pedal input p (i.e., driver-demanded braking torque q) based on the output signal of the pedal sensor 50. The driver-demanded braking torque q may increase over time as shown in FIG. 5.

The controller 150 may request regenerative braking from the driving apparatus 20 to acquire the regenerative braking torque w generated at the rear wheels.

The regenerative braking torque w may increase over time as shown by the dotted line in FIG. 5.

The controller 150 may set a regenerative compensation torque based on the difference between the driver-demanded braking torque q and the regenerative braking torque w. For example, the controller 150 may set the regenerative compensation torque by subtracting the regenerative braking torque w from the driver-demanded braking torque q.

The controller 150 may distribute the regenerative compensation torque to each axle according to an axle-specific braking ratio. For example, if the front wheel braking ratio is greater than the rear wheel braking ratio, the controller 150 may set the regenerative compensation torque for the front wheels to be greater than the regenerative compensation torque for the rear wheels.

The controller 150 may determine the total braking torque for each axle as the sum of the axle-specific regenerative braking torque and the friction braking torque. For example, the controller 150 may determine the total braking torque b of the rear wheels by summing the regenerative braking torque of the rear wheels and the friction braking torque of the rear wheels. Furthermore, the controller 150 may determine the friction braking torque of the front wheels as the total braking torque of the front wheels. The friction braking torque may refer to the braking torque generated by the friction between a pair of pad plates (161, 162 in FIG. 3) and the brake disc (DISC in FIG. 3).

The controller 150 may set a reference value based on the axle-specific braking ratio and the axle-specific total braking torque. For example, the controller 150 may set the reference value as the product of the axle-specific braking ratio and the total braking torque of the rear wheels.

The controller 150 may apply the axle-specific regenerative compensation torque to at least one of the front and rear wheels based on the comparison result between the reference value and the axle-specific total braking torque. Here, if the total braking torque a of the front wheels is within a set reference ratio range with respect to the reference value, the controller 150 may apply the axle-specific regenerative compensation torque c to the front and rear wheels based on the axle-specific braking ratio. For example, if the total braking torque of the front wheels is approximately 0.95 or more and approximately 1.05 or less of the reference value, the controller 150 may distribute the regenerative compensation torque to the front and rear wheels based on the axle-specific braking ratio.

When the total braking torque of the front wheels is less than the reference ratio range, the controller 150 may apply the axle-specific regenerative compensation torque c only to the front wheels. For example, if the total braking torque of the front wheels is less than about 0.95 of the reference value, the controller 150 may apply the regenerative compensation torque only to the front wheels.

When the total braking torque of the front wheels exceeds the reference ratio range, the controller 150 may apply the axle-specific regenerative compensation torque only to the rear wheels. For example, if the total braking torque of the front wheels exceeds about 1.05 of the reference value, the controller 150 may apply the regenerative compensation torque only to the rear wheels.

The reason for setting the reference ratio range to about 0.95 to about 1.05 is as follows. First, it is to prevent frequent chattering of the regenerative braking. If the controller 150 tries to control the total braking torque of the front wheels to exactly match the reference value, control will continuously occur even with minute changes. This may lead to instability of the controller 150 and may cause the regenerative braking to turn on and off frequently.

Next, it is to ensure control stability. By providing a margin of ±5% around the reference value to set a hysteresis zone, it is possible to prevent the braking torque ratio of the front and rear wheels from changing abruptly. This may contribute to improving the braking stability of the vehicle.

Next, it is to reduce the load on the controller 150. By setting the reference ratio range, no additional control action occurs when the total braking torque of the front wheels is within that range. This reduces unnecessary computations by the controller 150 and may improve the control efficiency of the controller 150.

Next, it is to ensure the continuity of regenerative braking. By applying the regenerative compensation torque only to the front wheels when the total braking torque of the front wheels is less than 0.95 of the reference value, and only to the rear wheels when it exceeds 1.05, the regenerative braking may transition smoothly.

Next, it is for the stability of the front-rear braking force distribution. The ±5% range is an optimal range that may balance control stability and regenerative braking efficiency in the front-rear braking force distribution of the vehicle. If this range is exceeded, the braking stability of the vehicle may be compromised, and if a narrower range is set, control chattering may occur.

Next, it is to account for sensor and actuator errors. In a real vehicle, there are measurement errors from sensors and control errors from actuators, and the ±5% range is a range that may appropriately accommodate these errors.

Next, it is to optimize the efficiency of regenerative braking. The reference ratio range allows for maintaining an appropriate distribution of braking force between the front and rear wheels while securing a margin to utilize regenerative braking as much as possible.

Through this reference ratio range, the controller 150 may maximize the efficiency of regenerative braking while ensuring the braking stability of the vehicle. In addition, it may achieve both the stability and efficiency of the controller 150, and may optimize the braking force distribution between the front and rear wheels.

As such, by controlling the total braking torque of the front wheels to be in the range of 0.95 to 1.05 of the reference value, the controller 150 may maintain the ratio between the total braking torque of the front wheels and the total braking torque of the rear wheels to be similar to the axle-specific braking ratio.

The controller 150 may set the friction braking torque related to at least one of the front and rear wheels to be the same as the axle-specific regenerative compensation torque. For example, if the regenerative compensation torque is applied only to the front wheels, the controller 150 may set the friction braking torque of the front wheels to be the same as the regenerative compensation torque of the front wheels. Also, if the regenerative compensation torque is applied only to the rear wheels, the controller 150 may set the friction braking torque of the rear wheels to be the same as the regenerative compensation torque of the rear wheels.

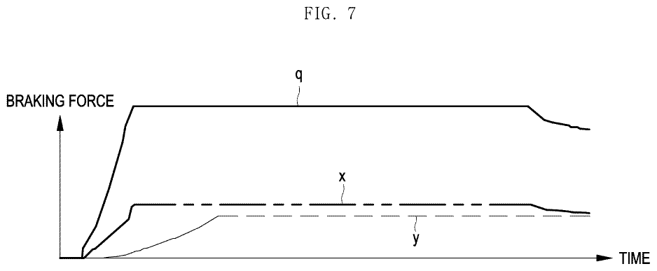

Referring to FIG. 7, the controller 150 may acquire the driver-demanded braking torque q based on the output signal of the pedal sensor 50.

The driver-demanded braking torque q may increase over time as shown by the solid line in FIG. 7.

The controller 150 may request regenerative braking from the driving apparatus 20 and acquire the regenerative braking torques x, y generated at the front and rear wheels.

The regenerative braking torque x of the front wheels may increase over time as shown by the first dotted line in FIG. 7, and the regenerative braking torque y of the rear wheels may increase over time as shown by the second dotted line in FIG. 7.

The controller 150 may set a regenerative compensation torque based on the difference between the driver-demanded braking torque q and the regenerative braking torques x, y. For example, the controller 150 may set the regenerative compensation torque by subtracting the sum of the front and rear wheel regenerative braking torques x, y from the driver-demanded braking torque q.

The controller 150 may distribute the regenerative compensation torque to each axle according to an axle-specific braking ratio. For example, if the front wheel braking ratio is greater than the rear wheel braking ratio, the controller 150 may set the regenerative compensation torque for the front wheels to be greater than the regenerative compensation torque for the rear wheels.

The controller 150 may determine the total braking torque for each axle as the sum of the axle-specific regenerative braking torque and the friction braking torque. For example, the controller 150 may determine the total braking torque of the front wheels by summing the regenerative braking torque of the front wheels and the friction braking torque of the front wheels, and may determine the total braking torque of the rear wheels by summing the regenerative braking torque of the rear wheels and the friction braking torque of the rear wheels.

The controller 150 may set the friction braking torque related to each of the front and rear wheels to be the same as the axle-specific regenerative compensation torque. For example, the controller 150 may set the friction braking torque of the front wheels to be the same as the regenerative compensation torque of the front wheels, and may set the friction braking torque of the rear wheels to be the same as the regenerative compensation torque of the rear wheels.

In this manner, the controller 150 may effectively combine regenerative braking and friction braking to control the vehicle's braking according to the driver's braking demand, and may maximize the efficiency of regenerative braking while appropriately maintaining the axle-specific braking ratio.

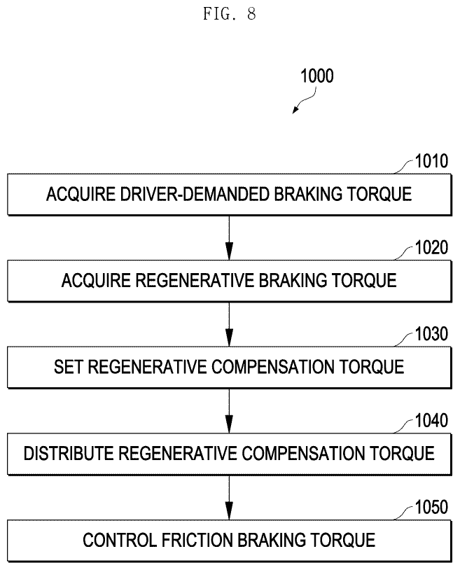

Hereinafter, a method for controlling a brake apparatus according to an embodiment of the disclosed invention will be described with reference to FIG. 8. The control method will be described based on the aforementioned brake apparatus.

Referring to FIG. 8, a method 1000 for controlling a brake apparatus according to an embodiment of the disclosed invention may include a step 1010 of acquiring a driver-demanded braking torque based on an output signal of a vehicle's pedal sensor, a step 1020 of requesting regenerative braking from the vehicle's driving apparatus to acquire the regenerative braking torque generated during said regenerative braking, a step 1030 of setting a regenerative compensation torque based on the difference between said driver-demanded braking torque and said regenerative braking torque, a step 1040 of distributing said regenerative compensation torque to each axle according to an axle-specific braking ratio, and a step 1050 of controlling the friction braking torque of each of said plurality of brakes based on the distributed said regenerative compensation torque.

Specifically, a step 1010 of acquiring the driver-demanded braking torque by the brake apparatus may be performed. The controller 150 may acquire the driver-demanded braking torque based on the output signal of the pedal sensor 50 provided in the vehicle. For example, the controller 150 may acquire the braking torque requested by the driver by processing the output signal of the pedal sensor 50 corresponding to the operation amount of the brake pedal 55.

Next, a step 1020 of acquiring the regenerative braking torque generated during regenerative braking by the brake apparatus may be performed. The controller 150 may request regenerative braking from the vehicle's driving apparatus 20 and receive regenerative braking torque information from the driving apparatus 20. For example, in the case of a rear-wheel drive vehicle, the controller 150 may acquire the regenerative braking torque generated at the rear wheels, and in the case of a 4-wheel drive vehicle, the controller 150 may acquire the regenerative braking torque generated at each of the front and rear wheels.

Next, a step 1030 of setting the regenerative compensation torque by the brake apparatus may be performed. The controller 150 may set the regenerative compensation torque based on the difference between the driver-demanded braking torque and the regenerative braking torque. For example, the controller 150 may set the regenerative compensation torque by subtracting the regenerative braking torque from the driver-demanded braking torque. At this time, in the case of a rear-wheel drive vehicle, the controller 150 may set the regenerative compensation torque by subtracting the regenerative braking torque of the rear wheels from the driver-demanded braking torque, and in the case of a 4-wheel drive vehicle, the controller 150 may set the regenerative compensation torque by subtracting the sum of the regenerative braking torques of the front and rear wheels from the driver-demanded braking torque.

Next, a step 1040 of distributing the regenerative compensation torque to each axle by the brake apparatus may be performed. The controller 150 may distribute the regenerative compensation torque to each axle according to the axle-specific braking ratio. For example, if the braking ratio of the front wheels is greater than the braking ratio of the rear wheels, the controller 150 may set the regenerative compensation torque of the front wheels to be greater than the regenerative compensation torque of the rear wheels.

The distribution of the axle-specific regenerative compensation torque may be performed based on the axle-specific total braking torque, which is determined by the sum of the axle-specific regenerative braking torque and the friction braking torque. The controller 150 may determine the total braking torque of the front wheels by summing the regenerative braking torque of the front wheels and the friction braking torque of the front wheels, and may determine the total braking torque of the rear wheels by summing the regenerative braking torque of the rear wheels and the friction braking torque of the rear wheels.

Furthermore, the distribution of the axle-specific regenerative compensation torque may be performed according to the comparison result with a reference value set based on the axle-specific braking ratio and the axle-specific total braking torque. The controller 150 may set the reference value as the product of the axle-specific braking ratio and the total braking torque of the rear wheels.

For example, if the total braking torque of the front wheels is approximately 0.95 or more and approximately 1.05 or less of the reference value, the controller 150 may distribute the regenerative compensation torque to the front and rear wheels based on the axle-specific braking ratio. In addition, if the total braking torque of the front wheels is less than about 0.95 of the reference value, the controller 150 may apply the regenerative compensation torque only to the front wheels. Conversely, if the total braking torque of the front wheels exceeds about 1.05 of the reference value, the controller 150 may apply the regenerative compensation torque only to the rear wheels.

Next, a step 1050 of controlling the friction braking torque by the brake apparatus may be performed. The controller 150 may control the friction braking torque of the plurality of brakes based on the distributed regenerative compensation torque. For example, in a rear-wheel drive vehicle, if the regenerative compensation torque is applied only to the front wheels, the controller 150 may set the friction braking torque of the front wheels to be the same as the regenerative compensation torque of the front wheels. Also, if the regenerative compensation torque is applied only to the rear wheels, the controller 150 may set the friction braking torque of the rear wheels to be the same as the regenerative compensation torque of the rear wheels.

In the case of a 4-wheel drive vehicle, the controller 150 may set the friction braking torque of the front wheels to be the same as the regenerative compensation torque of the front wheels, and may set the friction braking torque of the rear wheels to be the same as the regenerative compensation torque of the rear wheels.

The method for controlling a brake apparatus according to an embodiment of the disclosed invention may maximize the efficiency of regenerative braking while ensuring the braking stability of the vehicle. In particular, it may prevent the early occurrence of rear-wheel slip during cooperative regenerative braking control, and may maintain regenerative braking even during high deceleration, thereby improving the efficiency and coverage of regenerative braking.

Furthermore, the method for controlling a brake apparatus according to an embodiment of the disclosed invention may optimize the braking force distribution between the front and rear wheels by utilizing the independent control characteristics of the EMB system for each wheel. Through this, it is possible to improve the braking stability of the vehicle and maximize the efficiency of regenerative braking, thereby improving the fuel economy of the vehicle.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake apparatus comprising:
a plurality of brakes provided on left wheels and right wheels of each of a first axle and a second axle of a vehicle; and
a controller configured to acquire a driver-demanded braking torque based on an output signal of a pedal sensor provided in the vehicle, request regenerative braking from a driving device of the vehicle to acquire a regenerative braking torque generated during the regenerative braking, set a regenerative compensation torque based on a difference between the driver-demanded braking torque and the regenerative braking torque, distribute the regenerative compensation torque to each axle according to an axle braking ratio, and control a friction braking torque of each of the plurality of brakes based on the distributed regenerative compensation torque.

2. The brake apparatus of claim 1, wherein the regenerative braking torque includes an axle-specific regenerative braking torque of either the first axle or the second axle, and the controller is configured to set the axle braking ratio based on a difference between the driver-demanded braking torque and the axle-specific regenerative braking torque, and distribute the regenerative compensation torque to each axle based on the axle braking ratio.

3. The brake apparatus of claim 2, wherein the controller is configured to determine a total braking torque of each axle as a sum of the axle-specific regenerative braking torque and the friction braking torque.

4. The brake apparatus of claim 3, wherein the controller is configured to set a reference value based on the axle braking ratio and the total braking torque of each axle, and apply the regenerative compensation torque to at least one of the first axle and the second axle based on a comparison between the reference value and the total braking torque of each axle.

5. The brake apparatus of claim 4, wherein the controller is configured to set the reference value as a product of the axle braking ratio and the total braking torque of the second axle based on the regenerative braking torque generated from the second axle, and apply the regenerative compensation torque to the first and second axles based on the axle braking ratio when the total braking torque of the first axle is within a reference ratio range with respect to the reference value.

6. The brake apparatus of claim 5, wherein the controller is configured to apply the regenerative compensation torque to the first axle when the total braking torque of the first axle is less than the reference ratio range, and apply the regenerative compensation torque to the second axle when the total braking torque of the first axle exceeds the reference ratio range.

7. The brake apparatus of claim 5, wherein the reference ratio range is set to be equal to or greater than 0.95 times the reference value and equal to or less than 1.05 times the reference value.

8. The brake apparatus of claim 2, wherein the controller is configured to set the friction braking torque associated with at least one of the first axle and the second axle equal to the axle-specific regenerative compensation torque.

9. The brake apparatus of claim 1, wherein the vehicle is a four-wheel drive vehicle, the regenerative braking torque includes axle-specific regenerative braking torques of each of the first and second axles, and the controller is configured to set the axle braking ratio based on a difference between the driver-demanded braking torque and the axle-specific regenerative braking torques, and distribute the axle-specific regenerative compensation torque based on the axle braking ratio.

10. The brake apparatus of claim 9, wherein the controller is configured to set the friction braking torque associated with each of the first axle and the second axle equal to the axle-specific regenerative compensation torque.

11. A method for controlling a brake apparatus of a vehicle, comprising:
acquiring a driver-demanded braking torque based on an output signal of a pedal sensor of the vehicle;
requesting regenerative braking from a drive unit of the vehicle to acquire a regenerative braking torque generated during the regenerative braking;
setting a regenerative compensation torque based on a difference between the driver-demanded braking torque and the regenerative braking torque;
distributing the regenerative compensation torque to each axle according to an axle braking ratio; and
controlling a friction braking torque of each of a plurality of brakes based on the distributed regenerative compensation torque.

12. The method of claim 11, wherein the regenerative braking torque includes an axle-specific regenerative braking torque of either the first axle or the second axle, wherein setting the regenerative compensation torque comprises determining the axle braking ratio based on a difference between the driver-demanded braking torque and the axle-specific regenerative braking torque, and wherein distributing the regenerative compensation torque comprises allocating the regenerative compensation torque to each axle based on the axle braking ratio.

13. The method of claim 12, wherein distributing the regenerative compensation torque includes determining a total braking torque of each axle as a sum of the axle-specific regenerative braking torque and the friction braking torque.

14. The method of claim 13, wherein distributing the regenerative compensation torque includes setting a reference value based on the axle braking ratio and the total braking torque of each axle, and applying the regenerative compensation torque to at least one of the first axle and the second axle based on a comparison between the reference value and the total braking torque of each axle.

15. The method of claim 14, wherein distributing the regenerative compensation torque includes setting the reference value as a product of the axle braking ratio and the total braking torque of the second axle based on the regenerative braking torque generated from the second axle, and applying the regenerative compensation torque to the first and second axles based on the axle braking ratio when the total braking torque of the first axle is within a reference ratio range with respect to the reference value.

16. The method of claim 15, wherein distributing the regenerative compensation torque includes applying the regenerative compensation torque to the first axle when the total braking torque of the first axle is less than the reference ratio range, and applying the regenerative compensation torque to the second axle when the total braking torque of the first axle exceeds the reference ratio range.

17. The method of claim 15, wherein the reference ratio range is set to be equal to or greater than 0.95 times the reference value and equal to or less than 1.05 times the reference value.

18. The method of claim 12, wherein controlling the friction braking torque includes setting the friction braking torque associated with at least one of the first axle and the second axle equal to the axle-specific regenerative compensation torque.

19. The method of claim 11, wherein the vehicle is a four-wheel drive vehicle, the regenerative braking torque includes axle-specific regenerative braking torques of each of the first and second axles, the setting of the regenerative compensation torque includes setting the axle braking ratio based on a difference between the driver-demanded braking torque and the axle-specific regenerative braking torques, and the distributing of the regenerative compensation torque includes distributing the axle-specific regenerative compensation torque based on the axle braking ratio.

20. The method of claim 19, wherein controlling the friction braking torque includes setting the friction braking torque associated with each of the first axle and the second axle equal to the axle-specific regenerative compensation torque.
